(19) United States
(12) Patent Application Publication
(10) Pub. No.: US 2014/0329051 A1
(43) Pub. Date: Nov. 6, 2014

(54) Material Model that Couples Rotation of Micro Structural Elements with the Path of Energy Flux

(71) Applicant: Christine Marie Kennefick, Reston, VA (US)

(72) Inventor: Christine Marie Kennefick, Reston, VA (US)

(21) Appl. No.: 14/320,682

(22) Filed: Jul. 1, 2014

Related U.S. Application Data
(63) Continuation-in-part of application No. 13/445,946, filed on Apr. 13, 2012.

(51) Int. Cl. H01F 7/02

(52) U.S. Cl. CPC H01F 7/0273
USPC 428/141

(57) ABSTRACT

The invention is a material model that treats all charge carriers, micro structural elements and disturbances as sets of energy flux vectors. The curvature and direction of the path of the energy flux vectors are vector functions whose coefficients are summations of linear and trigonometric functions. The amplitude, frequency and phase angle of the trigonometric functions can be altered and optimized by elastic stress patterns in the material, by rotation of micro structural elements, or by other energy flux vectors themselves. The curvature, direction and optimization of the path of the energy flux vectors gives rise to electric potential, electric current, fracture resistance, or the absorption or emission of a set of energy flux vectors.

This application is a Continuation-in-Part of U.S. patent application Ser. No. 13/445,946 filed on Apr. 13, 2012, entitled: “Method and Device to Design, Store and Analyze Patterns of Three Dimensional Structural Elements at the Atomic, Nanoscale, Microscale and Larger Scale Levels”.

### TECHNICAL FIELD

The field of the invention is that of electromagnetics, electromechanics, electrical conduction, materials and mechanics.

### BACKGROUND ART

Other inventions have methods to maintain electric current that differ from the guidance of the shape of the path of energy flux vectors presented here. To control the electric potential of ions in a plasma, for example, two or more harmonic radio frequencies of voltage have been used (Heil, Brian George, et. al., U.S. Pat. No. 8, 643,280). Linear Faraday induction of electric current has been established by compressing magnets that provide a magnetic field through a coil array (Phillips, Reed E., U.S. Pat. No. 8,629,572). Still another method is to use solid state circuitry to reduce voltage drops (Chen, Ping, U.S. Pat. No. 8,699,249).

The guidance of acoustic and electromagnetic waves has been obtained by allowing the waves to reflect and recombine in phase to produce regions of high intensity (Rhaghavan, Raghu and Poston, Timothy, U.S. Pat. No. 8,582,397). The invention presented here, in contrast, works also with the wavelike properties of particles and treats all structures as groups of energy flux vectors that realign their directions to produce an energetically favorable mosaic of flux vectors. The mosaic of flux vectors can be determined by the twist and rotation of atomic clusters and grains. Such a mechanism is in contrast with the enhancement of protonic conduction by the incorporation of specific ions into the atomic lattice (Norby, Truls, et. al., U.S. Pat. No. 8,426,077). Determining the electric potential by the curvature of the path of energy flux vectors in the invention here differs from the placement of small capacitors and inductors and the use of an electric field to guide the wavelike nature of electrons that was utilized in another invention (Diduck, Quentin and Margala, Martin, U.S. Pat. No. 7,576, 353).

### SUMMARY OF THE INVENTION

The invention is a material texture that controls the direction and curvature of the path of energy flux vectors through elastic stress patterns and other sets of energy flux vectors. Sets of energy flux vectors define the flow of the electrical and mechanical energy of interest. Other energy flux vectors define the subatomic particles that comprise the atoms of larger structural elements, as well as the energy of a disturbance arriving from the exterior of the material or existing within the material. The energy flux vectors change direction through the twist and rotation of larger material texture units such as clusters, grains and particles. The elastic stress patterns control and alter the frequency and phase of the trigonometric functions that comprise the coefficients of the component vectors of the energy flux vectors.

### Advantageous Effects of the Invention

The invention offers advantages over those that set and maintain a traditional voltage between positive and negative charges. The invention here creates energy potentials by controlling the shape and curvature of the wavelike nature of charge carriers. It does this by aligning energy flux vectors favorably with other flux vectors that are altered by elastic stress patterns and structural elements intrinsic to a monolithic material. There is no need for external electric fields, or specially made structures such as dots, lines and layers. Secondly, the alignment of the energy flux vectors can beneficially occur over different length scales and allow for the emission and absorption of particles and radiation, if desired. Finally, the alignment of an entire mosaic of energy flux vectors can render a disturbance unable to adversely the performance of the device.

### BRIEF DESCRIPTION OF THE DRAWING

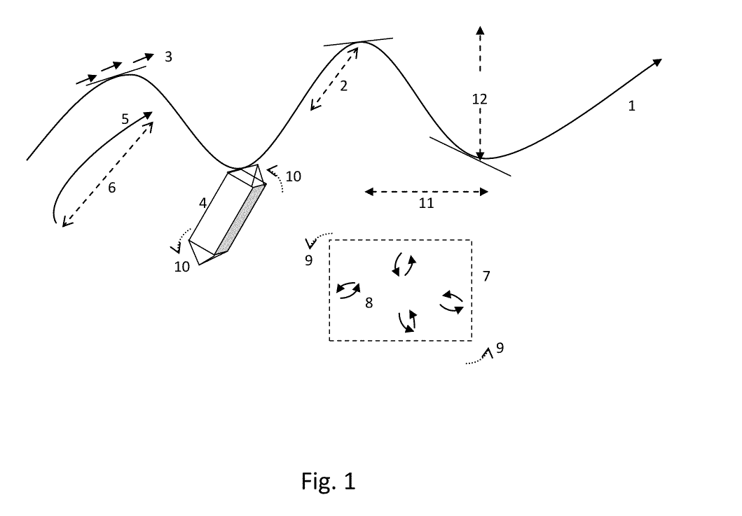

Reference will be made to FIG. 1, which shows the path of electrical or mechanical energy through a material texture containing microstructural elements and a disturbance.

### DETAILED DESCRIPTION OF THE INVENTION

The material model is any grouping of atoms, grains, particles, material phases, bimaterial interfaces or texture of potential energies. The energy flux vector has a magnitude of kinetic or potential energy and a direction normal to a unit area through which the energy transmits or changes magnitude.

The path and configuration of energy flux vectors differs from that of a simple electromagnetic wave that consists of sets of electric and magnetic fields oscillating perpendicular to one another. The rearrangement of energy flux vectors in the invention here, however, can utilize or emit electromagnetic waves. The path and configuration of the energy flux vectors may also be defined by the shape of the surface normal to the path of the flux vectors.

Element 1 in FIG. 1 shows the shape of a path of energy flux vectors of an electric or any other changes in energy potential that relies upon the shape of this path and its curvature rather than a traditional voltage for its variations in potential energy. The energy flux is defined by the energy flowing or changing in magnitude per unit area per unit time in the direction of path 1.

In any particular enablement of the invention, path 1 is kept to a shape and curvature 2 that optimizes electrical energy, strain energy or mechanical energy for the device. A higher electrical potential could occur, for example, where path 1 is relatively straight compared with regions where path 1 is more curved. Path 1 could be kept nearly straight, for example, by maximizing the number of points where the curvature is zero of a single sine function describing its shape, or by maximizing the number of arcs and segments where a sum of sine and cosine functions yields an arc of little curvature.

Path 1, or the surface normal to Path 1, can be kept to an optimum direction and curvature by keeping its energy flux vectors compatible in direction with the energy flux vectors 3 of an elastic stress pattern in the material. The energy flux vectors of an elastic stress pattern may be at the interface of one micro structural element 4 and the matrix material or anywhere in the matrix material 3. The energy flux vectors of Path 1, as well as those at the stress patterns 3 and 4, are kept at an optimum direction and curvature so as to eliminate or minimize the effect of the energy flux vectors of a disturbance 5 that have their own path of curvature 6.

Path 1 may also be kept to an optimum direction and curvature by aligning its energy flux vectors in a favorable manner with those of a cluster 7 of smaller micro structural elements, each having their own energy flux vectors 8. Each cluster might rotate elastically 9 to change the direction and phase of the path the energy flux vectors both within and outside the cluster. Rotation 10 might also occur with a larger micro structural element 4 to change the path of the energy flux vectors inside and outside the element.

The vector functions describing the shape of paths 1, 3, 5 and 8, or the surfaces normal to these paths, in an x, y, z coordinate system have a sum of linear and trigonometric functions as the coefficient of each unit vector in the x, y and z directions, respectively. Paths 1, 3, 8 and 8 in three dimensions can therefore be knot like, a single sinusoidal wave, a single closed loop, or nearly a straight line in a single direction. The energy flux vectors of paths 1, 3, 5 and 8 become favorably aligned by altering either the frequencies, phase angles, or the amplitudes of the trigonometric functions just mentioned that describe the shape of the path of the flux vectors.

A rearrangement of mathematical expression for the path of the energy flux vectors by frequency, phase angle or amplitude can occur over a length 11 that is characteristic of path 1. It can also occur over a larger length 12 between particular microstructural elements 4 or material phases whose volume fraction is defined by the length 12.

There can be several embodiments of the invention, some of which are mentioned here. In one embodiment of the invention, a form of electrical energy is induced and maintained that differs from a traditional voltage between positive and negative charges. In a second embodiment of the invention, the energy flux vectors are configured to promote the selective separation of two or more material elements. In a third embodiment of the invention, a set of energy flux vectors in a particular configuration interacts with incoming electromagnetic radiation and can indentify frequency or incoming direction of the radiation. In yet another embodiment of the invention, a set of energy flux vectors of a particular configuration separates and travels as a distinct signal from the material.

The material texture is designed first by assigning the desired shape of the path of the energy of the property of interest. Material elements are then added so that their energy flux vectors, upon rotation of the elements, guide or encapsulate the first set of energy flux vectors so that they remain in their desired configuration, even in the presence of yet a third set of energy flux vectors arising from a disturbance to the property of interest. The guidance or encapsulation of the shape of the path may be effected by the rotating elements by changing either the amplitude Aᵢ, the frequency wᵢ or the phase φᵢ in the trigonometric functions that are the coefficients of the total vector function describing the path or surface normal to the path.

As an example, the elements that rotate might keep the effective wave of a superconducting electron in a desired configuration for super conduction while cancelling out or rendering ineffective the energy flux vectors from vibrational displacement of atoms and from infrared waves from the thermal vibrations. As a second example, the energy flux of a hydrogen ion would be guided by the energy flux from the elements that rotate so that protonic conduction retains its strength across grain, interphase and bimaterial boundaries. As a third example, energy flux vectors would be kept in a stable configuration by the energy flux of rotating elements so that the first set of vectors does not assume a configuration that leads to stress concentration and crack propagation. In this last example, the energy flux vectors would be kept in a stable pattern in the presence of a third or fourth set of energy flux vectors from the force of wind or a magnetic field. In all these embodiments, someone skilled in the art of fabricating materials could then make the texture from crystals and particulates of the correct materials to render the desired clusters of atoms, grains, particulates, phases or bimaterial composite configurations.

### CITATIONS

| Pat. No. | Inventor(s) |
|---|---|
| 8,643,280 | Heil, Brian George, et. al. |
| 8,629,572 | Phillips, Reed E. |
| 8,699,249 | Chen, Ping |
| 8,582,397 | Rhaghavan, Raghu and Poston, Timothy |
| 8,426,077 | Norby, Truls, et. al. |
| 7,576,353 | Diduck, Quentin and Margala, Martin |

What is claimed:

1. A device and process in which electrical, strain and mechanical energy are created and maintained by the direction and curvature of the path of sets of energy flux vectors.

2. A material model which is contained whose charge carriers, microstructual elements and wavelike disturbances are all modeled as an entire mosaic comprised of individual sets of energy flux vectors.

3. A material model that controls electrical, strain and mechanical energy by the favorable realignment of any set or an entire mosaic of energy flux vectors and may allow for the beneficial absorption or emission of any set of energy vectors in the form of waves or particles.

4. A material model of claim 1, wherein the direction and curvature of the path of sets of energy flux vectors promote the selective separation of material by activating the motion of charge carriers and by redistributing buildup and release of elastic strain energy.

5. A material model of claim 1 in which the direction and curvature of the path of sets of energy flux vectors are defined and designed by the shape and curvature of the surface normal to the path of sets of energy flux vectors.
